(19) United States
(12) Patent Application Publication
(10) Pub. No.: US 2024/0107120 A1
(43) Pub. Date: Mar. 28, 2024

(54) AUTOMATED PLATFORM FOR GENERATING INTERACTIVE VIDEOS

(71) Applicant: JBF Interlude 2009 LTD, Tel Aviv (IL)

(72) Inventors: Jonathan Bloch, Ramat HaSharon (IL); Tal Zubalsky, Brooklyn, NY (US); Yuval Hofshy, Kfar Saba (IL); Alon Benari, Brooklyn, NY (US)

(21) Appl. No.: 18/528,925

(22) Filed: Dec. 5, 2023

Related U.S. Application Data
(63) Continuation of application No. 17/334,027, filed on May 28, 2021, now Pat. No. 11,882,337.

(51) Int. Cl. H04N 21/478; H04N 21/44; H04N 21/443; H04N 21/8545; H04N 21/858

(52) U.S. Cl. CPC H04N 21/47815; H04N 21/44008; H04N 21/4431; H04N 21/8545; H04N 21/8586

(57) ABSTRACT

Systems and methods generating interactive videos on an automated platform are provided herein. The example methods can include receiving data associated with at least one physical item and receiving video content comprising a visual presentation of the physical item. The method can include receiving a selection of a predetermined template, in which the template comprising a plurality of modules organized in a tree structure. The method can further include organizing the video content into the predetermined template to form organized video content, and embedding an object in a portion of the organized video content to form an interactive video, in which the object is based on the received data and is configured to enable at least one of: (i) user interaction with the physical item; or (ii) a link to a webpage associated with the physical item.

### CROSS-REFERENCE TO RELATED APPLICATIONS

This application is a Continuation of U.S. application Ser. No. 17/334,027 filed on May 28, 2021, which is hereby incorporated by reference in its entirety.

### TECHNICAL FIELD

The following disclosure is directed to methods and systems for generating interactive videos and, more specifically, an automated platform for generating interactive videos.

### BACKGROUND

Websites often present information about a given product for the purpose of selling the product to a customer of the website. Some of these websites include videos visually presenting the product (e.g., a new vehicle, a power tool, a toy, a bouquet of flowers, etc.). However, such videos are typically predetermined and unalterable by the video developer or the user.

### SUMMARY

Disclosed herein are systems and methods for generating interactive videos on an automated platform.

In one aspect, the disclosure features a method for generating interactive videos on an automated platform. The method can include receiving data associated with at least one physical item; receiving video content comprising a visual presentation of the physical item, and receiving a selection of a predetermined template. The template can include a plurality of modules organized in a tree structure. The method includes organizing the video content into the predetermined template to form organized video content, and embedding an object in a portion of the organized video content to form an interactive video. The object is based on the received data and is configured to enable at least one of: (i) user interaction with the physical item; or (ii) a link to a webpage associated with the physical item.

Various embodiments of the method can include one or more of the following features.

The received data can be received via an application program interface (API). The received data can include at least one of: (a) an image of the physical item; (b) a review of the physical item; (c) a text description of the physical item; (d) an inventory status of the physical item; or (e) at least one tag associated with the physical item. The received data can be inputted by a user of the platform, and wherein the received data comprises at least one of: (i) an identification number associated with the physical item; (ii) a webpage link associated with the physical item; (iii) a text description of the physical item; (iv) at least one tag associated with the physical item; or (v) at least one feature of the physical item and, for each feature, a respective interaction type. The webpage can be configured to enable purchase of the physical item.

The webpage can be configured to present information associated with the physical item. The method can include receiving a modification of the predetermined template, the modification being at least one of: (a) an addition of one or more modules to the tree structure; or (b) a modification of a connection between two modules of the tree structure. The predetermined template can be based on the physical item. The portion of the organized video can be assigned to a module of the plurality of modules. Transmitting the interactive video for presentation can include transmitting the interactive video to a website or an application.

In another aspect, the disclosure features a system for generating interactive videos on an automated platform. The system can include at least one memory for storing computer-executable instructions; and at least one processor for executing the instructions stored on the memory. The execution of the instructions can program the at least one processor to perform operations include receiving data associated with at least one physical item; receiving video content comprising a visual presentation of the physical item; and receiving a selection of a predetermined template, the template comprising a plurality of modules organized in a tree structure. The operations can include organizing the video content into the predetermined template to form organized video content; and embedding an object in a portion of the organized video to form an interactive video. The object can be based on the received data and is configured to enable at least one of: (i) user interaction with the physical item; or (ii) a link to a webpage associated with the physical item.

Various embodiments of the system can include one or more of the following features. The received data can be received via an application program interface (API). The received data comprises at least one of: (a) an image of the physical item; (b) a review of the physical item; (c) a text description of the physical item; (d) an inventory status of the physical item; or (e) at least one tag associated with the physical item. The received data is inputted by a user of the platform, and wherein the received data comprises at least one of: (i) an identification number associated with the physical item; (ii) a webpage link associated with the physical item; (iii) a text description of the physical item; (iv) at least one tag associated with the physical item; or (v) at least one feature of the physical item and, for each feature, a respective interaction type.

The webpage can be configured to enable purchase of the physical item. The webpage can be configured to present information associated with the physical item. The operations can include receiving a modification of the predetermined template. The modification can be at least one of: (a) an addition of one or more modules to the tree structure; or (b) a modification of a connection between two modules of the tree structure. The predetermined template can be based on the physical item. The portion of the organized video can be assigned to a module of the plurality of modules. Transmitting the interactive video for presentation can include transmitting the interactive video to a website or an application.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 depicts a high-level system architecture for providing interactive media content according to an implementation.

FIG. 2 is a flowchart of an example method for generating an interactive video on an automated platform.

FIG. 3 is a diagram of an example system including the automated platform.

FIG. 4A is a diagram illustrating example module types for use in the example system of FIG. 3. FIG. 4B is a diagram of an example project formed from five modules. FIG. 4C is a diagram of an example template for an interactive video.

FIG. 5A is a diagram of an example template organized serially for selecting features of a particular product. FIG. 5B is a diagram of a tree structure associated with the example template of FIG. 5A.

FIG. 6A is a diagram of an example template in which an interactive video enables multiple items to be selected. FIG. 6B provides a shopping list that may be compiled based on the end user selections made in the interactive video of FIG. 6A.

FIG. 7A is a diagram illustrating the adding of buttons into an example interactive video.

FIG. 7B is a diagram illustrating the adding of sections into an example interactive video. FIG. 7C is a diagram illustrating a section of video content added in a time-arranged sequence.

FIG. 8A is a high-level diagram illustrating the creation of a project without a template.

FIG. 8B is a high-level diagram illustrating the creation of a project with a template. FIG. 8C is a diagram of an example template in which the metadata can override the video content and the button configuration.

FIG. 9A is a diagram of an example interactive video configured on the platform app. FIG. 9B is a diagram of the example interactive video of FIG. 9A configured on a seller's webpage.

FIG. 10A is a diagram of an example interactive video configured on the platform app, in which a database is configured to collect data. FIG. 10B is a diagram of the example interactive video of FIG. 9A configured on a seller's webpage, in which a database is configured to collect data.

### DETAILED DESCRIPTION

Disclosed herein are exemplary embodiments of systems and methods for generating interactive videos. In particular, described are various embodiments of an automated platform for generating interactive videos.

### High-Level System Architecture

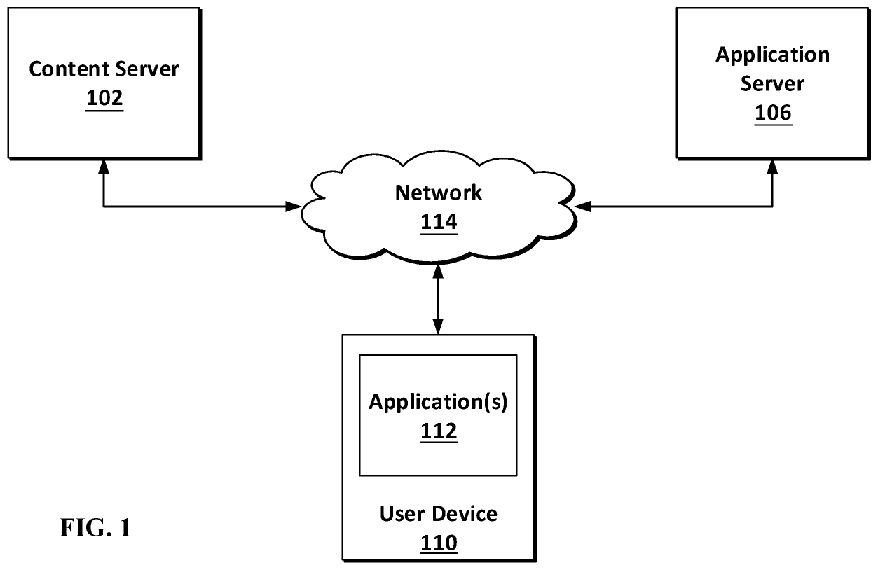

FIG. 1 depicts a high-level architecture of such a system according to an implementation. A media presentation having multiple video and/or audio streams can be presented to a user on a user device 110 having one or more application(s) 112 that together are capable of playing and/or editing the content and displaying a video library where information associated with videos can browsed and videos can be selected for playback. The user device 110 can be, for example, a smartphone, tablet, laptop, desktop, palmtop, television, gaming device, virtual reality headset, smart glasses, smart watch, music player, mobile telephone, workstation, or other computing device configured to execute the functionality described herein. The user device 110 can have output functionality (e.g., display monitor, touchscreen, image projector, etc.) and input functionality (e.g., touchscreen, keyboard, mouse, remote control, etc.).

The application 112 can be a video player/editor and library browser that is implemented as a native application, web application, or other form of software. In some implementations, the application 112 is in the form of a web page, widget, and/or Java, JavaScript, .Net, Silverlight, Flash, and/or other applet or plug-in that is downloaded to the user device 110 and runs in conjunction with a web browser. The application 112 and the web browser can be part of a single client-server interface; for example, the application 112 can be implemented as a plugin to the web browser or to another framework or operating system. Any other suitable client software architecture, including but not limited to widget frameworks and applet technology, can also be employed.

Media content can be provided to the user device 110 by content server 102, which can be a web server, media server, a node in a content delivery network, or other content source. In some implementations, the application 112 (or a portion thereof) is provided by application server 106. For example, some or all of the described functionality of the application 112 can be implemented in software downloaded to or existing on the user device 110 and, in some instances, some or all of the functionality exists remotely. For example, certain video encoding and processing functions can be performed on one or more remote servers, such as application server 106. In some implementations, the user device 110 serves only to provide output and input functionality, with the remainder of the processes being performed remotely.

The user device 110, content server 102, application server 106, and/or other devices and servers can communicate with each other through communications network 114. The communication can take place via any media such as standard telephone lines, LAN or WAN links (e.g., T1, T3, 56 kb, X.25), broadband connections (ISDN, Frame Relay, ATM), wireless links (802.11, Bluetooth, GSM, CDMA, etc.), and so on. The network 114 can carry TCP/IP protocol communications and HTTP/HTTPS requests made by a web browser, and the connection between clients and servers can be communicated over such TCP/IP networks. The type of network is not a limitation, however, and any suitable network can be used.

More generally, the techniques described herein can be implemented in any suitable hardware or software. If implemented as software, the processes can execute on a system capable of running one or more custom operating systems or commercial operating systems such as the Microsoft Windows® operating systems, the Apple OS X® operating systems, the Apple iOS® platform, the Google Android™ platform, the Linux® operating system and other variants of UNIX® operating systems, and the like. The software can be implemented a computer including a processing unit, a system memory, and a system bus that couples various system components including the system memory to the processing unit.

The system can include a plurality of software modules stored in a memory and executed on one or more processors. The modules can be in the form of a suitable programming language, which is converted to machine language or object code to allow the processor or processors to read the instructions. The software can be in the form of a standalone application, implemented in any suitable programming language or framework.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

It should also be noted that the present implementations can be provided as one or more computer-readable programs embodied on or in one or more articles of manufacture. The article of manufacture can be any suitable hardware apparatus, such as, for example, a floppy disk, a hard disk, a CD-ROM, a CD-RW, a CD-R, a DVD-ROM, a DVD-RW, a DVD-R, a flash memory card, a PROM, a RAM, a ROM, or a magnetic tape. In general, the computer-readable programs can be implemented in any programming language. The software programs can be further translated into machine language or virtual machine instructions and stored in a program file in that form. The program file can then be stored on or in one or more of the articles of manufacture.

### Media Presentations

The media presentations referred to herein can be structured in various forms. For example, a particular media presentation can be an online streaming video having multiple tracks or streams that a user can switch among in real-time or near real-time. For example, a media presentation can be structured using parallel audio and/or video tracks as described in U.S. patent application Ser. No. 14/534,626, filed on Nov. 6, 2014, and entitled “Systems and Methods for Parallel Track Transitions,” the entirety of which is incorporated by reference herein. More specifically, a playing video file or stream can have one or more parallel tracks that can be switched among in real-time automatically and/or based on user interactions. In some implementations, such switches are made seamlessly and substantially instantaneously, such that the audio and/or video of the playing content can continue without any perceptible delays, gaps, or buffering. In further implementations, switches among tracks maintain temporal continuity; that is, the tracks can be synchronized to a common timeline so that there is continuity in audio and/or video content when switching from one track to another (e.g., the same song is played using different instruments on different audio tracks; same storyline performed by different characters on different video tracks, and the like).

Such media presentations can also include interactive video structured in a video tree, hierarchy, or other form. A video tree can be formed by nodes that are connected in a branching, hierarchical, or other linked form. Nodes can each have an associated video segment, audio segment, graphical user interface (GUI) elements, and/or other associated media. Users (e.g., viewers) can watch a video that begins from a starting node in the tree and proceeds along connected nodes in a branch or path. Upon reaching a point during playback of the video where multiple video segments (child nodes) branch off from a segment (parent node), the user can interactively select the branch or path to traverse and, thus, the next video segment to watch.

As referred to herein, a particular branch or path in an interactive media structure, such as a video tree, can refer to a set of consecutively linked nodes between a starting node and ending node, inclusively, or can refer to some or all possible linked nodes that are connected subsequent to (e.g., sub-branches) or that include a particular node. Branched video can include seamlessly assembled and selectably presentable multimedia content such as that described in U.S. patent application Ser. No. 13/033,916, filed on Feb. 24, 2011, and entitled “System and Method for Seamless Multimedia Assembly” (the “Seamless Multimedia Assembly application”), and U.S. patent application Ser. No. 14/107,600, filed on Dec. 16, 2013, and entitled “Methods and Systems for Unfolding Video Pre-Roll,” the entireties of which are hereby incorporated by reference.

The prerecorded video segments in a video tree or other structure can be selectably presentable multimedia content; that is, some or all of the video segments in the video tree can be individually or collectively played for a user based upon the user's selection of a particular video segment, an interaction with a previous or playing video segment, or other interaction that results in a particular video segment or segments being played. The video segments can include, for example, one or more predefined, separate multimedia content segments that can be combined in various manners to create a continuous, seamless presentation such that there are no noticeable gaps, jumps, freezes, delays, or other visual or audible interruptions to video or audio playback between segments. In addition to the foregoing, “seamless” can refer to a continuous playback of content that gives the user the appearance of watching a single, linear multimedia presentation, as well as a continuous playback of multiple content segments that have smooth audio and/or video transitions (e.g., fadeout/fade-in, linking segments) between two or more of the segments.

In some instances, the user is permitted to make choices or otherwise interact in real-time at decision points or during decision periods interspersed throughout the multimedia content. Decision points and/or decision periods can occur at any time and in any number during a multimedia segment, including at or near the beginning and/or the end of the segment. Decision points and/or periods can be predefined, occurring at fixed points or during fixed periods in the multimedia content segments. Based at least in part on the user's choices made before or during playback of content, one or more subsequent multimedia segment(s) associated with the choices can be presented to the user. In some implementations, the subsequent segment is played immediately and automatically following the conclusion of the current segment, whereas in other implementations, the subsequent segment is played immediately upon the user's interaction with the video, without waiting for the end of the decision period or the end of the segment itself.

If a user does not make a selection at a decision point or during a decision period, a default, previously identified selection, or random selection can be made by the system. In some instances, the user is not provided with options; rather, the system automatically selects the segments that will be shown based on information that is associated with the user, other users, or other factors, such as the current date. For example, the system can automatically select subsequent segments based on the user's IP address, location, time zone, the weather in the user's location, social networking ID, saved selections, stored user profiles, preferred products or services, and so on. The system can also automatically select segments based on previous selections made by other users, such as the most popular suggestion or shared selections. The information can also be displayed to the user in the video, e.g., to show the user why an automatic selection is made. As one example, video segments can be automatically selected for presentation based on the geographical location of three different users: a user in Canada will see a twenty-second beer commercial segment followed by an interview segment with a Canadian citizen; a user in the US will see the same beer commercial segment followed by an interview segment with a US citizen; and a user in France is shown only the beer commercial segment.

Multimedia segment(s) selected automatically or by a user can be presented immediately following a currently playing segment, or can be shown after other segments are played. Further, the selected multimedia segment(s) can be presented to the user immediately after selection, after a fixed or random delay, at the end of a decision period, and/or at the end of the currently playing segment. Two or more combined segments can form a seamless multimedia content path or branch, and users can take multiple paths over multiple playthroughs, and experience different complete, start-to-finish, seamless presentations. Further, one or more multimedia segments can be shared among intertwining paths while still ensuring a seamless transition from a previous segment and to the next segment. The content paths can be predefined, with fixed sets of possible transitions in order to ensure seamless transitions among segments. The content paths can also be partially or wholly undefined, such that, in some or all instances, the user can switch to any known video segment without limitation. There can be any number of predefined paths, each having any number of predefined multimedia segments. Some or all of the segments can have the same or different playback lengths, including segments branching from a single source segment.

Traversal of the nodes along a content path in a tree can be performed by selecting among options that appear on and/or around the video while the video is playing. In some implementations, these options are presented to users at a decision point and/or during a decision period in a content segment. Some or all of the displayed options can hover and then disappear when the decision period ends or when an option has been selected. Further, a timer, countdown or other visual, aural, or other sensory indicator can be presented during playback of content segment to inform the user of the point by which he should (or, in some cases, must) make his selection. For example, the countdown can indicate when the decision period will end, which can be at a different time than when the currently playing segment will end. If a decision period ends before the end of a particular segment, the remaining portion of the segment can serve as a non-interactive seamless transition to one or more other segments. Further, during this non-interactive end portion, the next multimedia content segment (and other potential next segments) can be downloaded and buffered in the background for later playback (or potential playback).

A segment that is played after (immediately after or otherwise) a currently playing segment can be determined based on an option selected or other interaction with the video. Each available option can result in a different video and audio segment being played. As previously mentioned, the transition to the next segment can occur immediately upon selection, at the end of the current segment, or at some other predefined or random point. Notably, the transition between content segments can be seamless. In other words, the audio and video continue playing regardless of whether a segment selection is made, and no noticeable gaps appear in audio or video playback between any connecting segments. In some instances, the video continues on to another segment after a certain amount of time if none is chosen, or can continue playing in a loop.

In one example, the multimedia content is a music video in which the user selects options upon reaching segment decision points to determine subsequent content to be played. First, a video introduction segment is played for the user. Prior to the end of the segment, a decision point is reached at which the user can select the next segment to be played from a listing of choices. In this case, the user is presented with a choice as to who will sing the first verse of the song: a tall, female performer, or a short, male performer. The user is given an amount of time to make a selection (i.e., a decision period), after which, if no selection is made, a default segment will be automatically selected. The default can be a predefined or random selection. Of note, the media content continues to play during the time the user is presented with the choices. Once a choice is selected (or the decision period ends), a seamless transition occurs to the next segment, meaning that the audio and video continue on to the next segment as if there were no break between the two segments and the user cannot visually or audibly detect the transition. As the music video continues, the user is presented with other choices at other decisions points, depending on which path of choices is followed. Ultimately, the user arrives at a final segment, having traversed a complete multimedia content path.

### Interactive Videos for Physical Items

In various embodiments, interactive videos may feature one or more physical items, e.g., for the purpose of selling the item, for educating a user about the item, for training a user about the item, etc. Example embodiments of the interactive videos may enable a user to interact with a representation of an item. In some embodiments, the interactive video may be configured such that the user is able to interact with the representation of the item within the video, outside of the video, adjacent to the video, etc.

For example, in the context of a product on sale (e.g., a car, a shirt, gym equipment, etc.), the video featuring the product may be configured to enable a user to interact with the representation of the product, the product's features, types of the product, options for the product, accessories for the product, other products similar and/or related to the product, etc. In this way, the user can explore and learn more about the product before making a purchasing decision. In another example, in the context of an educational video featuring a subject item, the video may be configured to present a representation of the subject item (e.g., a whale, a circuit, a plant, a book, etc.). The user (e.g., student, trainee, etc.) can interact with the subject item to learn more about and/or investigate the features of the subject item, reconfigurability of the item, etc. It is understood that, while this disclosure features systems and methods for generating interactive videos for products, the example systems and methods described herein can be applied to interactive videos featuring educational items, training items, items subject to investigation, items subject to analysis, etc.

In various embodiments, the interactive video can be included (integrated, embedded, etc.) in a website, an app for a mobile device, on an automated platform, etc. For example, the interactive video featuring a product may be on the product-specific webpage or a product detail page (PDP) of the app or platform. In another example, the interactive video can be part of a retail website (e.g., Nike.com, Toyota.com, Samsung.com, etc.) or a part of an online marketplace (e.g., Walmart.com, Amazon.com, etc.).

### Automated Platform and Related Methods

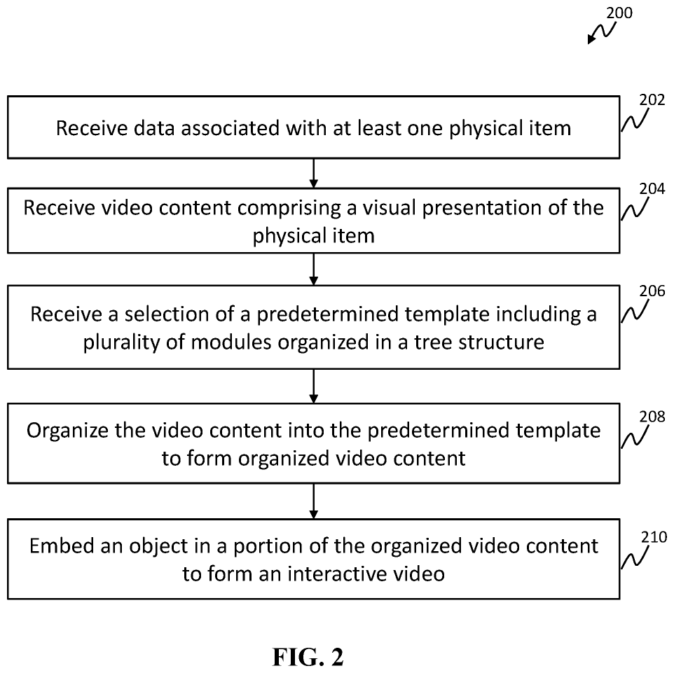

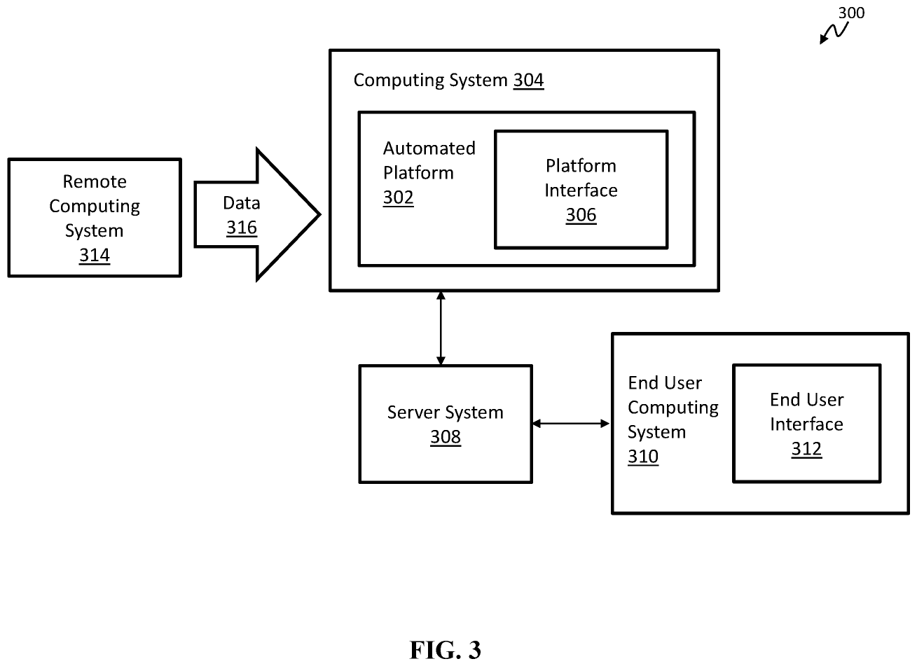

In various embodiments, an automated platform can be configured to generate an interactive video. FIG. 2 shows a flowchart of an example method for generating an interactive video on an automated platform. FIG. 3 illustrates a diagram of an example system including the automated platform. For the sake of clarity and conciseness, FIGS. 2-3 are discussed together herein. The term “publisher” is used to refer to the user that is involved in generating the interactive videos and the term “end user” is used to refer to the user that interacts with the interactive videos.

Referring to FIG. 3, the example system 300 may include an automated platform 302 hosted on a computing system 304. In some embodiments, the automated platform 302 includes a platform interface 306. A server system 308 may be configured to be connected (e.g., via an API, via the cloud, a computer network, etc.) to the computing system 304. The server system 308 may be configured to be connected (e.g., via an API, via the cloud, a computer network, etc.) to an end user computing system 310. The end user computing system 310 may have an end user interface 312. The end user computing system 310 may be a mobile device, a smartphone, a tablet computer, a laptop computer, a notebook computer, a set of smart glasses, a smart watch, a headset, etc. Note that the system 300 may be communicably connected (e.g., via an API, via the cloud, a computer network, etc.) to other computing systems, e.g., remote computing system 314.

In step 202, the system 300 (e.g., automated platform 302) can be configured to receive data 316 associated with at least one physical item. The received data 316 may be streamed, received via an application programming interface (API), received in one or more data files, and/or received in a bulk data transfer. The received data 316 to may be inputted by the publisher and/or obtained from a remote computing system 314. For example, the data 316 may include an identification number or code associated the item (e.g., a stock keeping unit (SKU), an ID number, etc.), a link to a website (e.g., a URL) associated with the item, a text description associated with the item, one or more tags associated with the item, a list of features associated with the item, one or more images of the item, one or more videos associated with the item, one or more videos associated with the item feature, one or more audio data associated with the item, and/or one or more audio data associated with the item features. For example, the received data 316 for a particular product may include a product name, one or more pictures of the product, customer reviews of the product, a product description, inventory status, one or more tags, an identification number, etc. As described further below, one or more of these data may be used or presented in or adjacent to the interactive video featuring the product item.

In step 204, the system 300 can be configured to receive video content including a visual presentation of one or more physical items. In some embodiments, the interactive video features one item. In some embodiments, the interactive video features two or more options (e.g., color, size, similar products, etc.) for the same item. In some embodiments, the interactive video features two or more items. For example, an interactive video can feature a cooking video with a grocery shopping list of ingredients used in the video. In another example, an interactive video for skiing or snowboarding can feature multiple pieces of clothing, equipment, accessories, etc. for purchase.

In step 206, the system 300 can be configured to receive a selection of a predetermined template. The predetermined template may include two or more modules (also referred to as “sections”) organized in a tree structure. Note that the system 300 may store and/or reference one or more templates based on the item, a feature of the item, a tag associated with the item, the publisher's preference, etc. Different templates may be associated with different tree structures, may have different appearances, and/or accommodate different data (e.g., video, audio, etc.) associated with the item. The publisher can select an appropriate template for a given item; add, remove, or adjust modules; adjust the associated tree structure; add, remove, or adjust the data in the template.

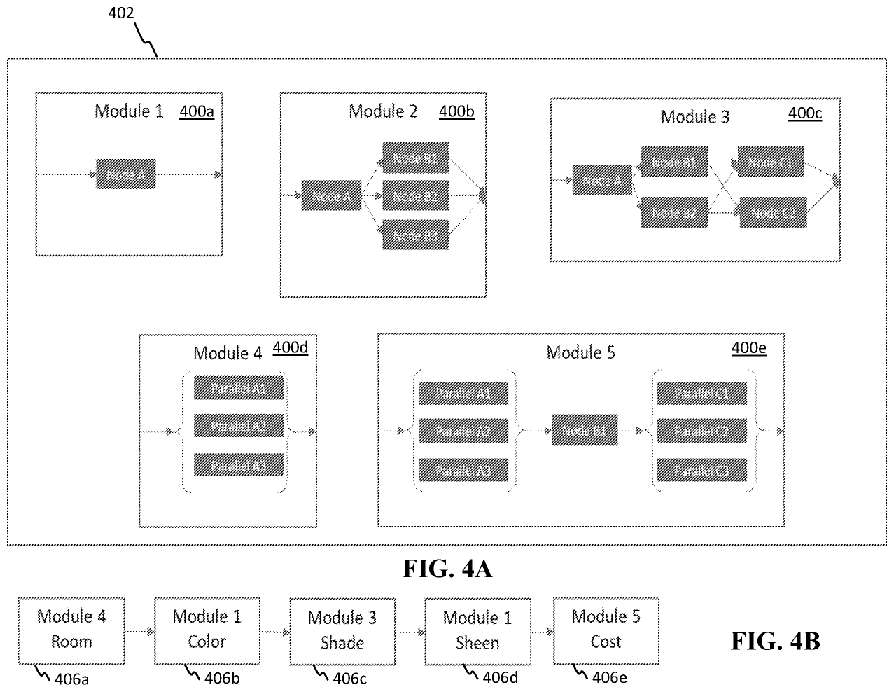

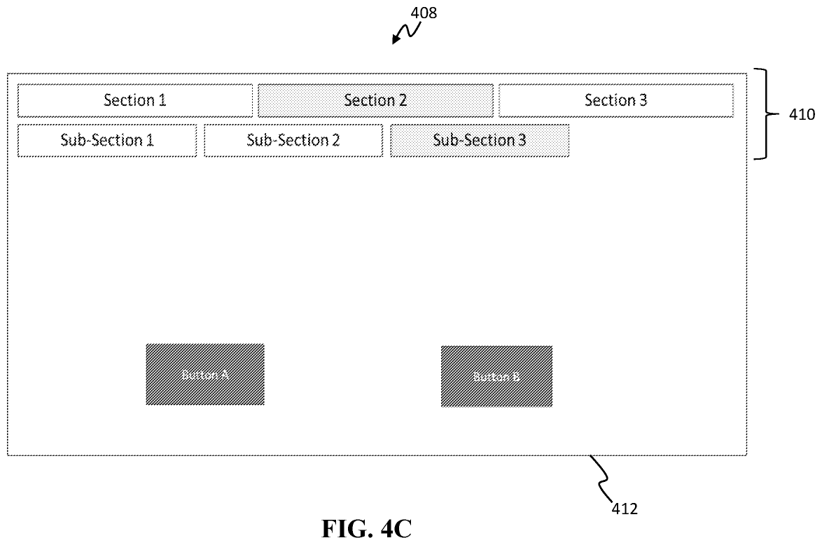

FIG. 4A illustrates example module types for use in system 300. A given module may include one or more nodes arranged in a tree structure. Illustrated are module type 1 (400a), module type 2 (module 400b), module type 3 (module 400c), module type 4 (module 400d), and module type 5 (module 400e) (collectively referred as module types 400). It is understood that other types and/or configurations of modules are within the scope of this disclosure. For instance, module type 1 may include a single node A having an input (connected to the input of the module 400a) and an output (connected to the output of the module 400a). Module type 2 may include node A having an input (connected to the input to the module 400b) and an output connected to the inputs of nodes B1, B2, and B3. Nodes B1, B2, and B3 can be arranged in parallel. The outputs of nodes B1, B2, and B3 can form the output of module 400b. Module type 3 may include a node A having an input (connected to the input of the module 400c) and an output connected to the inputs of node B1 and node B2 (which can be arranged in parallel to one another). The outputs of node B1 and node B2 can be connected to the inputs of node C1 and node C2. The outputs of node C1 and node C2 can be connected to the output of module 400c. Module type 4 may include parallel node A1, node A2, and node A3. The input of module 400d can be connected to one or more of the parallel nodes and the output of one or more of the parallel nodes can be connected to the output of the module 400d. Module type 5 can include parallel node A1, node A2, and node A3. The input of module 400e can be connected to one or more of the parallel nodes A1, A2, A3. The output of one or more of the parallel nodes can be connected to the input of node B1. The output of node B1 can be connected to one or more of the inputs of parallel nodes C1, C2, C3. The outputs of parallel nodes C1, C2, C3 can be connected to the output of module 400e. In various embodiments, one or more modules 400 of types 1-5 can be part of a project workspace 402. These modules 400 can be selected and/or organized by a user (e.g., a publisher) working in the project workspace 402.

FIG. 4B illustrates an example project 404 formed from five modules. In this example, the project 404 is for an interactive video enabling the selection of a wall paint. The project includes module 406a (of type 4) enabling the selection of a room (e.g., in a residence); module 406b (of type 1) enabling the selection of a color; module 406c (of type 3) enabling the selection of a shade; module 406d (of type 1) enabling the selection of a sheen; and module 406e (of type 5) enabling the selection of cost.

FIG. 4C illustrates an example template 408. As illustrated, the template 408 includes an index of sections at the top 410 of the frame 412. The interactive video may play inside the frame 412 as it is being configured for interactivity. The example template 408 may include two or more sections (e.g., Section 1, Section 2, Section 3), two or more sub-sections (e.g., Sub-Section 1, Sub-Section 2, Sub-Section 3), and two or more buttons (e.g., Button A, Button B). The sections and/or the subsections can each be associated with a particular interactive aspect of the video. The buttons can be configured by the publisher to enable a user select a feature or option in the interactive video.

In step 208, the system 300 can be configured to organize the video content into the predetermined template to form organized video template. In some embodiments, the video content may be received in portions and/or divided into portions after receipt. These video content portions may be organized into sections (and/or subsections). For example, a template for an interactive video featuring a toy may organize received video content such that the interactive video includes a first section for unboxing the toy, a second section for playing with the toy, and exploring the features of the toy. In another example, a template for an interactive video featuring a fashion product (e.g., clothes, accessories, shoes, etc.) may include a first section for the user to select a fashion influencer, a second section to view a product associated with the influencer, a third section to select a color, and a fourth section to select a color.

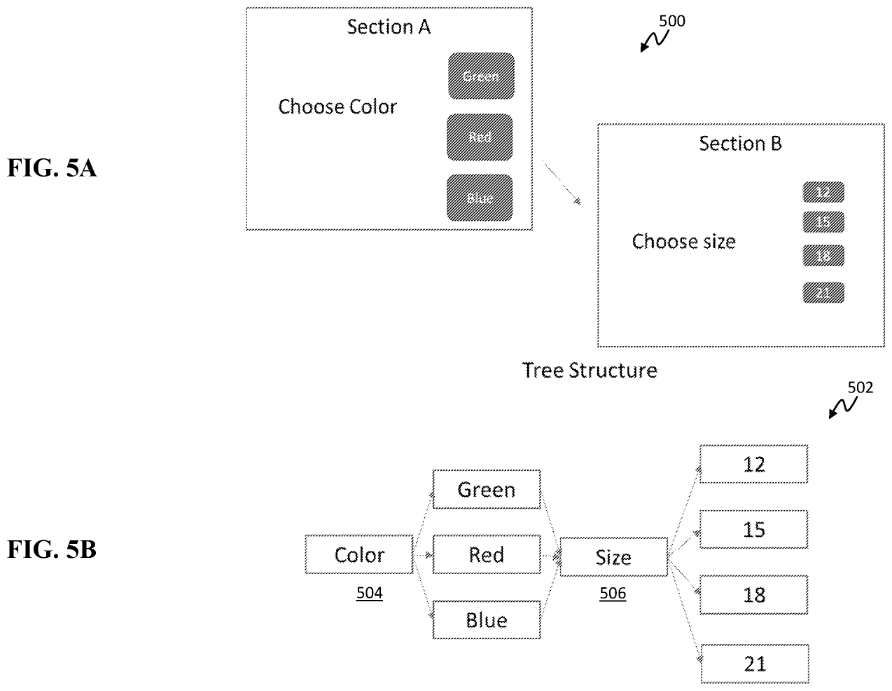

In step 210, an object (e.g., a button, an interactive element, a slide, etc.) may be embedded in a portion of the video content (e.g., in a section) to enable the end user to interact with the video. FIG. 5A illustrates example template 500 (or part of a template) organized serially (e.g., sequentially, in time, etc.) for selecting features of a particular product (e.g., item of clothing). The template 500 includes a first section (Section A) in which the end user is prompted to select a color of the product (e.g., green, red, or blue) and a second section (Section B) in which the end user is prompted to select a size of the product (e.g., 12, 15, 18, 21). As illustrated in FIG. 5B, the tree structure 502 is arranged such that the color branch 504 splits into three branches (one for each color green, red, blue). The color branches lead to the size branch 506, which splits into four branches (one for size 12, size 15, size 18, and size 21).

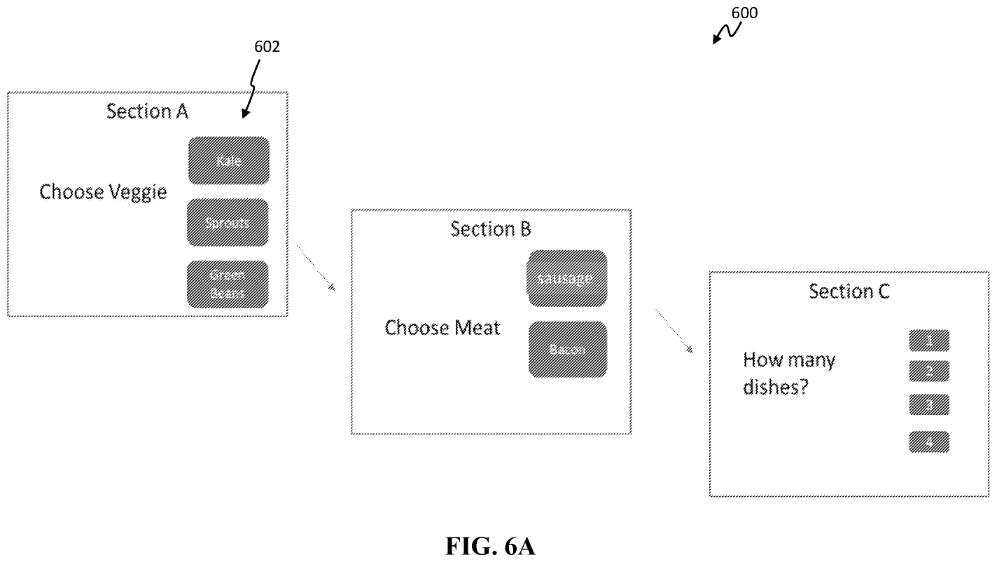

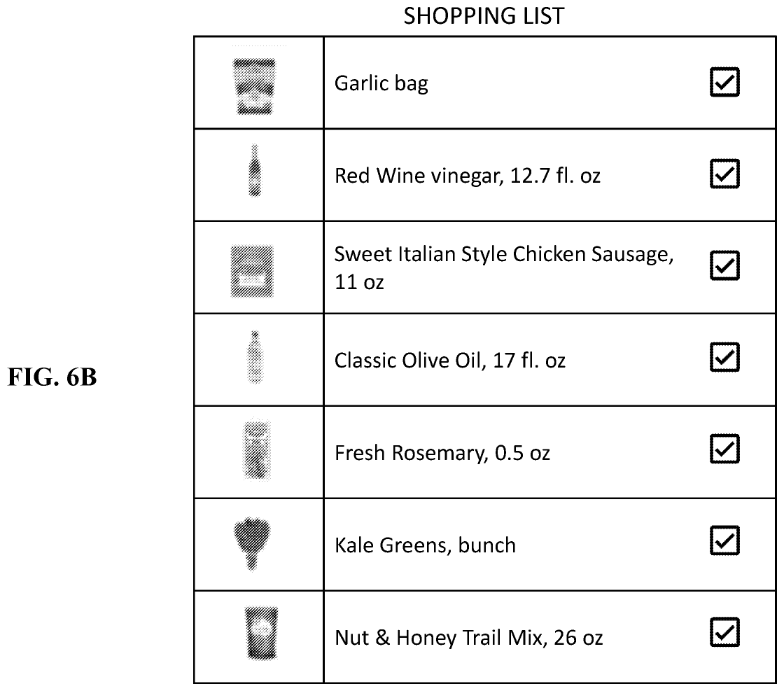

FIG. 6A provides an example template 600 in which an interactive video enables multiple items to be selected. In this example, each section may include a video content portion associated with a food (e.g., a segment of a cooking video in which one or more ingredients are added). Therefore, in Section A, a video portion (e.g., associated with a vegetable component) may play and buttons (e.g., to types of vegetables respectively) may appear before, during, or after the video portion plays. Once a selection is made (e.g., button “Kale”), the interactive video moves to the next section having the next video content portion (e.g., associated with a meat component). Again, a selection of a button (e.g., sausage) is made and the video content in Section C is played. Note that this sequence may include more or less sections. The sections may be of different lengths. For example, FIG. 6B provides a shopping list that may be compiled based on the end user selections made in previous sections. It is understood that a similar list may be compiled based on an interactive video for winter sports equipment, a car with trim options, a product with various configurations, etc.

In some embodiments, the interactive video may be configured to wait for end user interaction (e.g., via a button) to move to the next section. In some embodiments, the interactive video may be configured to automatically select a button for the end user after some time period (or make no selection) and move to the next section.

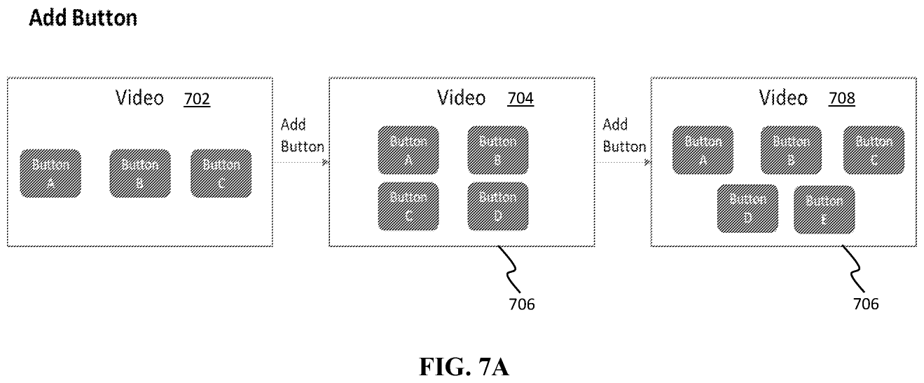

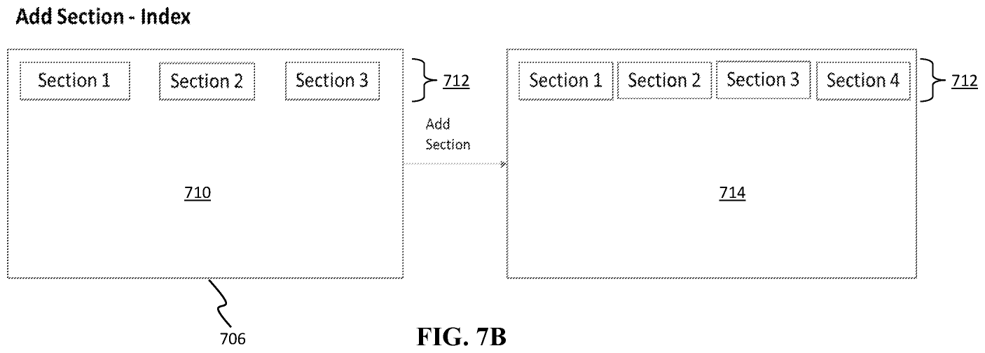

In some embodiments, the interactive video may be altered before, during, or after the video is “live” on a website. For example, one or more aspects of the template and/or the video content (e.g., buttons, sections, subsections, timeline, video content, data) may be adjusted. FIG. 7A illustrates the adding of buttons into an interactive video 702. In this example, interactive video 702 includes buttons A, B, and C. The publisher can add a button D to create 704. In some embodiments, the template is configured to enable the buttons A, B, C, and D to distribute automatically based on their number over the area inside the frame 706. Adding a button to video 704 causes the arrangement displayed in video 708, in which the five buttons are distributed in the frame 706. In some embodiments, this predetermined distribution of buttons is adjustable by the publisher. Note that the buttons described herein may be positioned anywhere within a frame (e.g., of the interactive video, of the player of the video, etc.), at the perimeter of the video, outside the video on the webpage.

In FIG. 7B, the publisher can choose to add or subtract sections from an interactive video 710. In the illustrated example, the publisher has added a fourth section, which is added to the index at the top of the frame 712 to form interactive video 714. FIG. 7C illustrates an embodiment in which a section of video content is added in a time-arranged sequence. In particular, in interactive video 716, Section A (selecting a color of the item) passes to Section B (selecting a size of the item). The platform 302 enables the publisher to add a section between Sections A and B. For example, a new Section B (selecting a gender) is added between selecting a color in Section A and selecting a size in new Section C (old Section B). Note that the changes described herein to the interactive video has a corresponding effect in the tree structure for the interactive video.

In some embodiments, a template for an interactive video may be embedded into a website and may be configured to be “overridden” by data associated with the webpage. For instance, the template can include placeholder sections, buttons, fields, video content, images, number of template elements (e.g., sections, subsections, buttons, etc.), location of elements, etc. The template may then be overridden by the website in real time or near real time. The features of the template that can be overridden may be included in metadata associated with the template and/or webpage carrying the template. A publisher may choose to embed the template into multiple webpages (e.g., each webpage featuring a different model of a shoe, an online marketplace featuring a wide variety of products, etc.) and override the template with content and/or configurations specific to the item on that webpage. In some embodiments, the configuration of template, video content, and/or related data can be stored within data of the webpage.

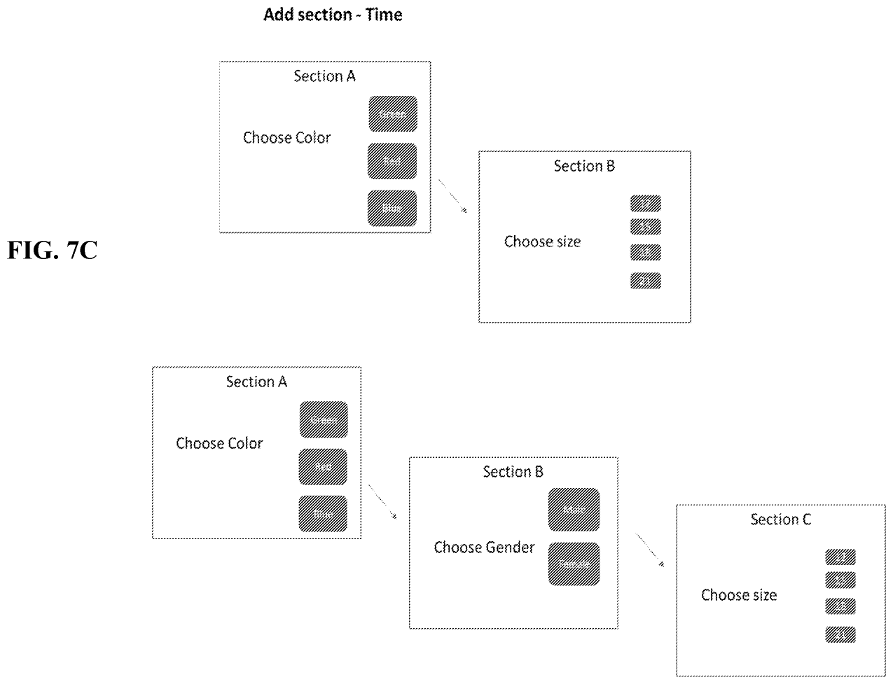

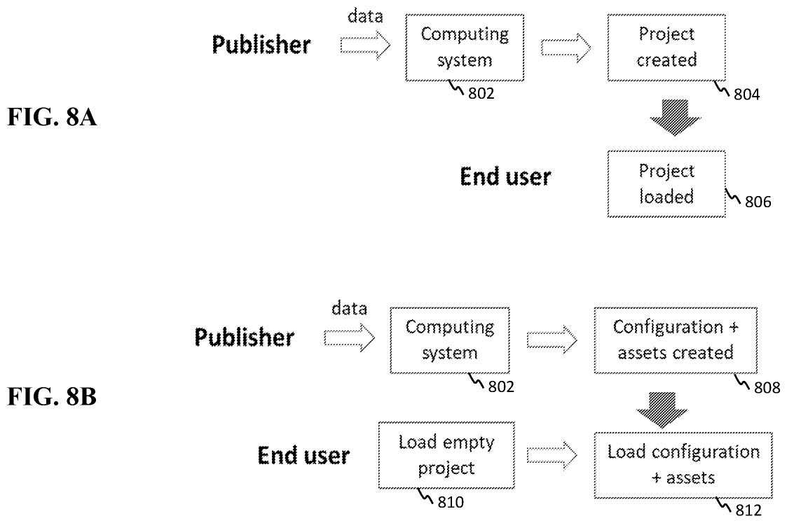

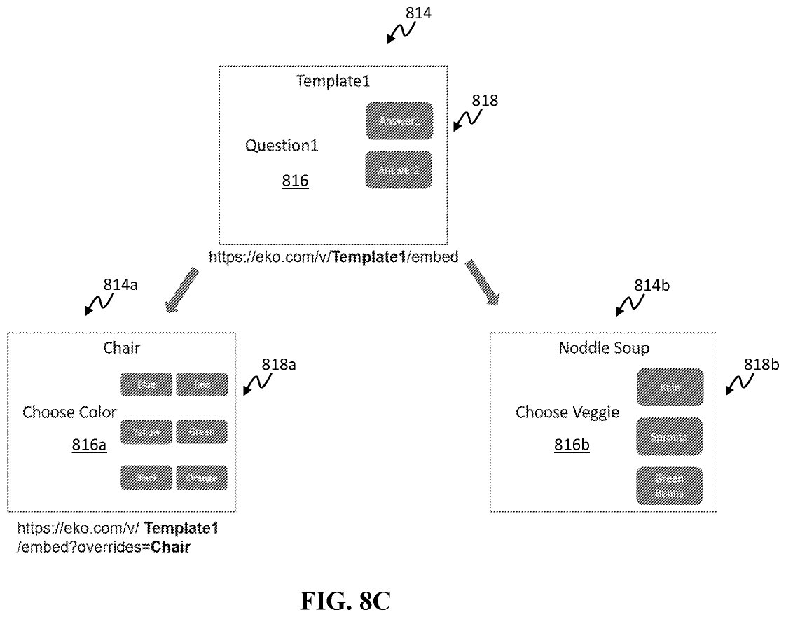

FIG. 8A illustrates, at a high level, the creation of a project without a template. In this case, the publisher inputs data into a computing system 802, which is configured to create the project 804. The end user then can load the created project 806 (e.g., onto a client device) and interact with the interactive video therein.

FIG. 8B illustrates, at a high level, the creation of a project with a template. In this case, the publisher inputs data into a computing system 802, which can create a configuration file. In the same step (or a separate step), assets (e.g., video file(s), audio file(s), metadata, etc.) can be added to the configuration file, creating a combined file 808. The end user can load an empty project 810 (e.g., on a client device) and the combined file 808 (or, alternatively, the configuration file and assets separately) can be loaded onto the empty project 810 to form the loaded project 812. In some cases, the loading of the empty project 810 and the loading of the combined filed 812 (or separate configuration file and assets) can be done in near-real time or real time.

FIG. 8C illustrates such a template 814 in which the metadata can override the video content 816 and the button configuration 818. For example, the template is embedded in website with a link: http://ek.com/v/Template1/embed. For a webpage featuring a chair 814a, the video content 816 may be overridden with video content 816a asking for user input on color. Accordingly, button configuration 818 may change to button configuration 818a to display various colors associate with the chair item. Additionally, the website link may change to: https://eko.com/v/Template1/embed?overides=Chair. Alternatively, the video content 816 may be overridden with video content 816b (e.g., for noodle soup) and button configuration 818 may be overridden with buttons 818b.

In some embodiments, each configuration of the template has an associated identification number. For example, in the above, the configuration of the template 814a for the chair interactive video has a different identification number than the configuration of the template 814b for the noodle soup interactive video. In some embodiments, the publisher is able to preview the interactive project in sandbox mode to determine any additional configuration or data needed for the websites.

In some embodiments, the platform 302 can include an automatic testing function and/or program (referred to as a tester) that is configured to determine whether a particular implementation of an interactive video is correct. For example, the tester can be configured to determine whether each section (e.g., node) has video content, whether each button is operational (e.g., responsive to user input), whether links to other websites are operational, whether the video content is in the intended size and/or format, whether analytics are being sent from the webpage, whether the API to the platform is valid, etc. If there are any issues as a result of testing, a substitute interactive video, a static video, or a static image may be placed temporarily while the issue is resolved (e.g., by the publisher).

### End User Interaction and Related Analytics

In various embodiments, the end user of the platform 302 may be assigned a user identification number (referred to as “user_id”). The platform 302 may be configured to manage purchases and/or other transactions using this user_id. The end user may interact with the interactive video on website (e.g., of a merchant, organization, school, etc.) or on the platform 302.

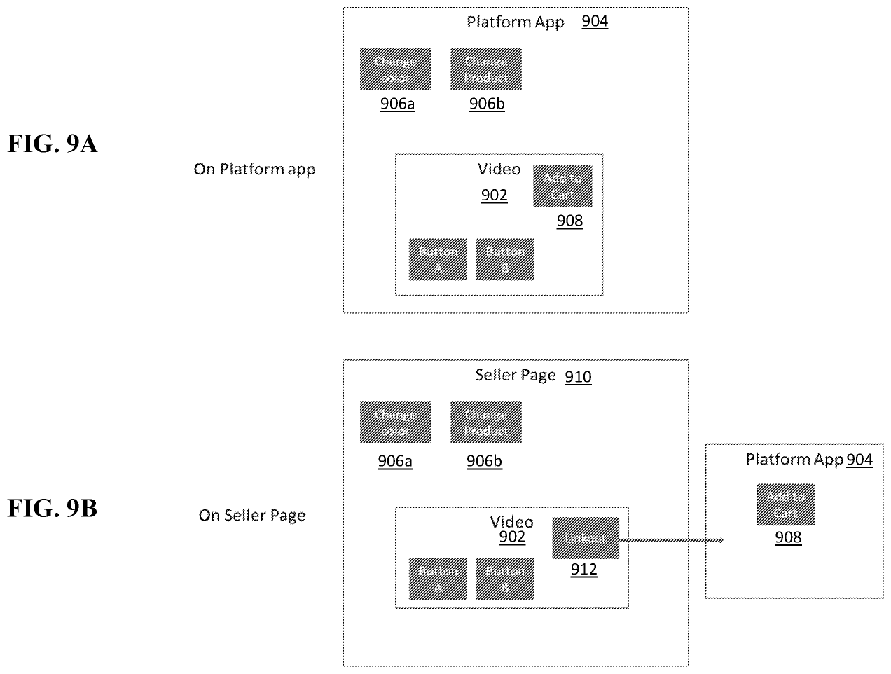

FIG. 9A illustrates an example interactive video 902 as it is configured on the platform app 904. The platform app 904 includes data associated with sections 906a (e.g., change of color) and 906b (e.g., change of product). The interactive video 902 may be presented in platform interface 306 and can include buttons A, B. The video 902 may also include an option for the end user to add the product that is the subject of the video to shopping cart 908.

FIG. 9B illustrates the example interactive video 902 as it is configured on a seller's webpage 910. In this example, the interactive video 902 may include a link 912 to the shopping cart 908 hosted by the platform app 904. In other examples, the cart may be directly hosted by the seller's webpage 910.

In some embodiments, the platform 302 is configured to execute one or more analytical programs (referred to as analytics) on the interactive video, webpage, and/or app page to monitor and/or collect data on user interactions (e.g., selections, purchases, etc.). For example, this data can be used for marketing, product optimization, inventory optimization, etc. The data can be used by the merchant to determine which products are selected more than others, interacted with more frequently and/or for longer amounts of time, and/or purchased more often. In some cases, the data can be used to determine configurations for existing and/or future interactive videos. The analytics may keep track of user interactions via the user_id, the session associated with the playing of the video via the session identification number (referred to as session_id), the item identification number (referred to as the item_id), the URL, etc.

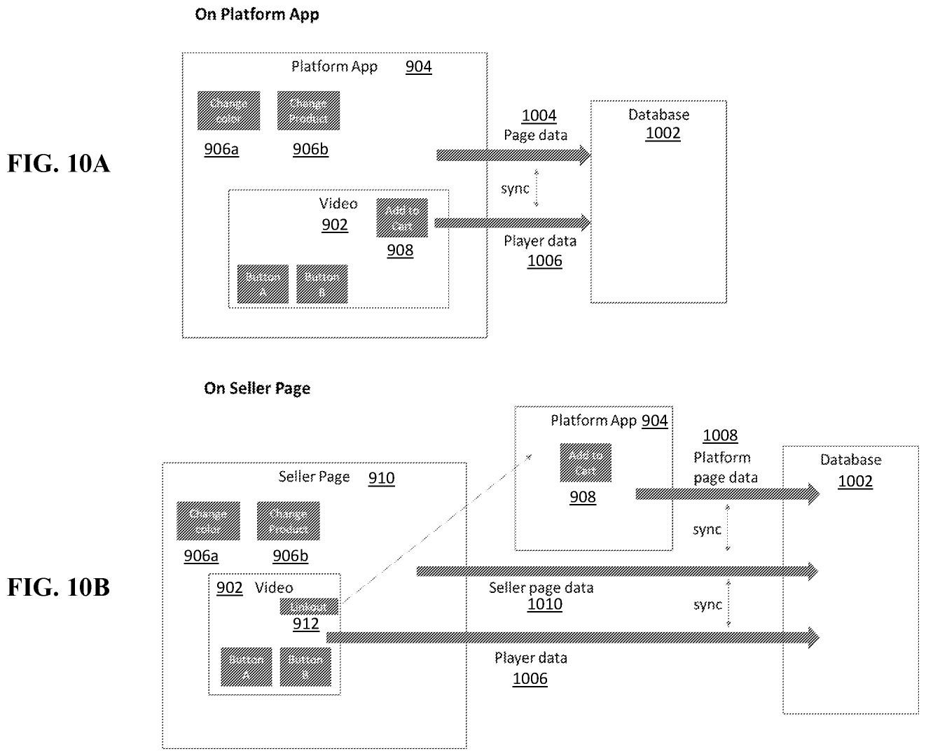

FIG. 10A illustrates the example interactive video 902 hosted by the platform app 904, as discussed above. In this example, a database 1002 is communicably connected to the platform app 904. The database 1002 may be hosted on the computing system 304 and/or a remote computing system. The page data 1004 and/or the player data 1006 (of the interactive video) may be sent to database 1002. In some embodiments, the page data 1004 and the player data 1006 may be synchronized, e.g., for the same session_id.

FIG. 10B illustrates the example interactive vide 902 as configured on a seller's webpage 910. In this example, the database is communicably connected to the seller's page 910, the player, and/or the platform app 904. The page data 1008, the player data 1006, and/or platform page data 1008 may be transmitted to database 1002.

### Terminology

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A method for generating interactive videos on an automated platform, the method comprising:
receiving data associated with a plurality of products;
receiving video content comprising visual presentations of the plurality of products;
receiving a selection of a predetermined template based on the plurality of products, the template comprising a plurality of video modules organized in a video tree structure configured to accommodate the data associated with the plurality of products and the visual presentations of the plurality of products, wherein each video module of the plurality of video modules includes at least one node of the video tree structure and at least one video module of the plurality of video modules includes an arrangement of two or more nodes;
organizing the received video content into the predetermined template to form organized video content, wherein organizing the received video content includes assigning a portion of the received video content to each node included in each video module of the plurality of video modules; and
embedding at least one interactive object in the video content assigned to at least one node of at least one video module of the plurality of video modules, wherein the at least one interactive object is based on the received data and is configured to enable at least one of:
(i) a user interaction with at least one product of the plurality of products; or
(ii) a link to a webpage associated with at least one product of the plurality of products.

2. The method of claim 1, wherein each video module of the plurality of video modules is configured to represent a different product of the plurality of products.

3. The method of claim 1, wherein at least one video module of the plurality of video modules is configured to represent two or more different products of the plurality of products.

4. The method of claim 1, wherein at least one video module of the plurality of video modules represents a product category that is associated with two or more different products of the plurality of products.

5. The method of claim 1, wherein each user interaction corresponds to at least one of:
(a) a selection of at least one product for purchase;
(b) a selection of a quantity of the at least one product; or
(c) a selection of an attribute of the at least one product.

6. The method of claim 1, further comprising:
generating a user shopping list based on the user interactions, wherein the user shopping list includes at least a portion of the plurality of products.

7. The method of claim 1, further comprising:
generating a comparable product list based on the user interactions, wherein the comparable product list includes two or more products from the plurality of products that have comparable product characteristics.

8. The method of claim 1, wherein the received data is received via an application program interface (API).

9. The method of claim 1, wherein the received data comprises at least one of:
(a) an image of at least one product of the plurality of products;
(b) a review of at least one product of the plurality of products;
(c) a text description of at least one product of the plurality of products;
(d) an inventory status of at least one product of the plurality of products; or
(e) at least one tag associated with at least one product of the plurality of products.

10. The method of claim 1, wherein the received data is inputted by a user of the platform, and wherein the received data comprises at least one of:
(i) an identification number associated with at least one product of the plurality of products;
(ii) a webpage link associated with at least one product of the plurality of products;
(iii) a text description of at least one product of the plurality of products;
(iv) at least one tag associated with at least one product of the plurality of products; or
(v) at least one feature of at least one product of the plurality of products and, for each feature, a respective interaction type.

11. The method of claim 1, wherein the webpage is configured to enable purchase of at least one product of the plurality of products.

12. The method of claim 1, wherein the webpage is configured to present information associated with at least one product of the plurality of products.

13. The method of claim 1, further comprising receiving a modification of the predetermined template, the modification being at least one of:
(a) an addition of one or more video modules to the video tree structure; or
(b) a modification of a connection between two video modules of the video tree structure.

14. The method of claim 1, further comprising:
transmitting the interactive video to a website or an application for presentation.

15. A system for generating interactive videos on an automated platform, the automated system comprising:
at least one memory for storing computer-executable instructions; and
at least one processor for executing the instructions stored on the memory, wherein execution of the instructions programs the at least one processor to perform operations comprising:
receiving data associated with a plurality of products;
receiving video content comprising visual presentations of the plurality of products;
receiving a selection of a predetermined template based on the plurality of products, the template comprising a plurality of video modules organized in a video tree structure configured to accommodate the data associated with the plurality of products and the visual presentations of the plurality of products, wherein each video module of the plurality of video modules includes at least one node of the video tree structure and at least one video module of the plurality of video modules includes an arrangement of two or more nodes;
organizing the received video content into the predetermined template to form organized video content, wherein organizing the received video content includes assigning a portion of the received video content to each node included in each video module of the plurality of video modules; and
embedding at least one interactive object in the video content assigned to at least one node of at least one video module of the plurality of video modules, wherein the at least one interactive object is based on the received data and is configured to enable at least one of:
(i) a user interaction with at least one product of the plurality of products; or
(ii) a link to a webpage associated with at least one product of the plurality of products.

16. The system of claim 15, wherein each video module of the plurality of video modules is configured to represent a different product of the plurality of products.

17. The system of claim 15, wherein at least one video module of the plurality of video modules is configured to represent two or more different products of the plurality of products.

18. The system of claim 15, wherein at least one video module of the plurality of video modules represents a product category that is associated with two or more different products of the plurality of products.

19. The system of claim 15, wherein each user interaction corresponds to at least one of:
(a) a selection of at least one product for purchase;
(b) a selection of a quantity of the at least one product; or
(c) a selection of an attribute of the at least one product.

20. The system of claim 15, wherein the operations further comprise:
generating a user shopping list based on the user interactions, wherein the user shopping list includes at least a portion of the plurality of products.

21. The system of claim 15, wherein the operations further comprise:
generating a comparable product list based on the user interactions, wherein the comparable product list includes two or more products from the plurality of products that have comparable product characteristics.

22. The system of claim 15, wherein the received data is received via an application program interface (API).

23. The system of claim 15, wherein the received data comprises at least one of:
(a) an image of at least one product of the plurality of products;
(b) a review of at least one product of the plurality of products;
(c) a text description of at least one product of the plurality of products;
(d) an inventory status of at least one product of the plurality of products; or
(e) at least one tag associated with at least one product of the plurality of products.

24. The system of claim 15, wherein the received data is inputted by a user of the platform, and wherein the received data comprises at least one of:
(i) an identification number associated with at least one product of the plurality of products;
(ii) a webpage link associated with at least one product of the plurality of products;
(iii) a text description of at least one product of the plurality of products;
(iv) at least one tag associated with at least one product of the plurality of products; or
(v) at least one feature of at least one product of the plurality of products and, for each feature, a respective interaction type.

25. The system of claim 15, wherein the webpage is configured to enable purchase of at least one product of the plurality of products.

26. The system of claim 15, wherein the webpage is configured to present information associated with at least one product of the plurality of products.

27. The system of claim 15, wherein the operations further comprise receiving a modification of the predetermined template, the modification being at least one of:
(a) an addition of one or more video modules to the video tree structure; or
(b) a modification of a connection between two video modules of the video tree structure.

28. The system of claim 15, wherein the operations further comprise:
transmitting the interactive video to a website or an application for presentation.
